(19) United States
(12) Patent Application Publication
(10) Pub. No.: US 2020/0356911 A1
(43) Pub. Date: Nov. 12, 2020

(54) DYNAMIC ROUTING OF VEHICLES THROUGH ESTABLISHED CORRIDORS

(71) Applicant: Uber Technologies, Inc., San Francisco, CA (US)

(72) Inventors: Mustafa Sahin, San Francisco, CA (US); Vishnu Sundaresan, San Francisco, CA (US); Meisam Vosoughpour, San Francisco, CA (US); Kenneth Kuhn, San Franciscco, CA (US); Miraj Rahematpura, San Francisco, CA (US); Li Li, San Francisco, CA (US); Yang Zhao, San Francisco, CA (US); Danhua Guo, San Francisco, CA (US); Eoin O'Mahony, San Francisco, CA (US); Lior Seeman, San Francisco, CA (US); Jasim Mohammed, San Francisco, CA (US); Denny Tse-Wei Tsai, San Francisco, CA (US); Philippe Sekine, San Francisco, CA (US)

(21) Appl. No.: 16/406,772

(22) Filed: May 8, 2019

(51) Int. Cl. G06Q 10/04; G06Q 50/30

(52) U.S. Cl. CPC G06Q 10/047; G06Q 50/30

(57) ABSTRACT

A computing system can assign a transport request to a high capacity vehicle (HCV) corridor of a plurality of HCV corridors, where the HCV corridor is associated with a plurality of possible rendezvous locations and a plurality of possible routes that can be traveled by individual HCVs. The computing system can determine, from the transport request of the requesting user, an optimal pick-up location from the plurality of possible rendezvous locations of the HCV corridor for an HCV to rendezvous with the requesting user.

### BACKGROUND

High capacity transit through metropolitan areas typically involves trains and/or buses traveling fixed routes with fixed pick-up and drop-off stations and on fixed schedules.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 illustrates a portion of a road network map including visualizations of route corridors through which high capacity vehicles (HCVs) may be dynamically routed to service transport requests, according to examples provided herein;

FIG. 2 illustrates computing system for coordinating navigation of HCVs through established corridors, in accordance with examples described herein;

FIG. 3 is an example computing device utilized by requesting users and drivers of an on-demand transport service, as described herein;

FIGS. 4 and 5 are flow charts describing example methods of dynamically routing HCVs through established corridors of a transport service region; and

FIG. 6 is a block diagram illustrating an example computer system upon which examples described herein may be implemented,

### DETAILED DESCRIPTION

According to examples described herein, a road network map for a geographic region can be parsed into corridors for high capacity vehicles (HCVs) to fulfill transport demand for a significant portion of the geographic region. Each HCV corridor can include a general start location or start area and a general end location or end area and can include any number of pick-up and drop-off locations therebetween. In some examples, the pick-up and drop-off locations can comprise fixed locations as determined from historical transport data for the geographic region (e.g., indicating historical pick-up and drop-off locations or clusters of such locations over a given duration of time). Numerous different routes, which comprise individual sets of route segments, are possible for each HCV corridor from the start locations or areas and end locations or areas. Furthermore, in some examples, each HCV corridor can be directional in nature such that an HCV traveling along a particular route (of many possible directional routes through the HCV corridor) must begin at the start location or area, and finish the HCV corridor at the end location or area. In variations, an HCV may be routed into an HCV corridor at any point after the start location, and can also be routed out of the corridor at any point before the end location (e.g., in response to real-time increases or decreases in transport demand within the corridor).

A computing system is provided herein that utilizes the HCV corridors to coordinate pick-ups and drop-offs of requesting riders/users by HCVs. The HCVs can each be operated by a driver or, in some aspects, can comprise autonomous HCVs. For human driven aspects, the driver of an HCV can input an available or on-duty state on a transport service application that communicates with the computing system. After detecting the available or on-duty state of a driver of an HCV, the computing system can route the driver, via instructions sent to the transport service application, to a start point of a particular HCV corridor. Accordingly, each HCV corridor can have any number of HCVs being directionally routed from a start point to an end point through the HCV corridor.

The computing system can receive transport requests from requesting users throughout the geographic region. In one example, the computing system can determine whether the pick-up location and the destination location of the transport request fits within a particular HCV corridor, and if so, the computing system can match the requesting user to the HCV corridor and determine an optimal pick-up location for the requesting user to rendezvous with an upcoming HCV operating within the matching corridor. In another example, the requesting user can specifically request the HCV service as part of the transport request, or the requesting user can operate a designated service application for requesting HCVs. In such examples, the computing system can determine which particular HCV corridor is best suited for the transport request.

As provided herein, the upcoming HCV may be operating along a current route, which the computing system can dynamically alter at any given time based on received transport requests from requesting users (e.g., requests received in a forward operational direction of the HCV within the corridor, such as after the HCV has departed from the start location or area). According to one example, the computing system may alter the dynamic route for each HCV based on a cost function that outputs a weighted cost for diverging the HCV based on an optimization of various factors, such as an arrival time of the upcoming HCV to each of one or more possible pick-up locations, traffic conditions through each possible route, a wait time for the requesting user, an added time for the upcoming HCV to diverge from the current route, a number of current passengers of the upcoming HCV, current transport demand and/or forecasted transport demand on other possible routes of the matching HCV corridor, and the like.

In additional implementations, the computing system can monitor real-time transport demand and HCV supply conditions in each HCV corridor, and can dynamically move HCVs to enter any specified segment of a corridor, move HCVs between corridors, and/or move HCVs to exit any particular segment of a corridor. For example, the computing system can determine that real-time HCV transport demand has become thin in a forward operational direction of an HCV operating through a particular corridor (e.g., below a threshold ratio of demand versus supply), while demand has spiked in a nearby corridor. In such examples, the computing system can route the HCV out of its current corridor and into any particular segment of the nearby corridor. In responding to real-time transport demand in each corridor, the computing system can utilize dynamic routing, scheduling, and gate keeping techniques described herein.

As provided herein, an “HCV corridor” can correspond to a segment of a road network that traverses across a given area (e.g., a metropolitan area). The HCV corridor can encompass more than one parallel road at any given portion, and can further comprise multiple fixed or dynamic pick-up and drop-off locations over the course of the HCV corridor. Accordingly, any number of routes (e.g., hundreds or thousands) through the HCV corridor are possible. Furthermore, the HCV corridor can be directional in nature, such that HCVs traversing through the HCV corridor generally traverse through the HCV corridor in one direction (e.g., as directed or coordinated by dynamic routing resources of a remote computing system). In various implementations, the HCV corridor can further be managed in accordance with an inflow schedule, such that individual HCVs enter the start point of the corridor at established time intervals. In such examples, the determination of the inflow schedule can be based on historical demand data compiled by the computing resources of the on-demand transport service (e.g., based on various transport options offered by the transport service).

Among other benefits, the examples described herein achieve a technical improvement upon existing high capacity transit options involving fixed routes, fixed schedules, and fixed pick-up and drop-off locations. Using historical data of existing on-demand transport, the computing system described herein can establish optimal corridors through a given region based on “hot spot” pick-up and drop-off areas, and dynamically route HCVs through such corridors based on real-time transport requests received from users of the on-demand transport service. It is further contemplated that implementations described herein can further increase high capacity transit usage for any given transport service region, thereby reducing the costs of transport as well as traffic congestion and harmful vehicle emissions caused by more individualized transport options.

One or more aspects described herein provide that methods, techniques and actions performed by a computing device are performed programmatically, or as a computer-implemented method. Programmatically means through the use of code, or computer-executable instructions. A programmatically performed step may or may not be automatic.

One or more aspects described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, virtual reality (VR) or augmented reality (AR) systems, network equipment (e.g., routers) and tablet devices. Memory, processing, and network resources may all be used in connection with the establishment, use, or performance of any example described herein (including with the performance of any method or with the implementation of any system).

Furthermore, one or more aspects described herein may be implemented through the use of instructions that are executable by one or more processors. These instructions may be carried on a computer-readable medium. Machines shown or described with figures below provide examples of processing resources and computer-readable media on which instructions for implementing some aspects can be executed. In particular, the numerous machines shown in some examples include processors and various forms of memory for holding data and instructions. Examples of computer-readable media include permanent memory storage devices, such as hard drives on personal computers or servers. Other examples of computer storage media include portable storage units, such as CD or DVD units, flash or solid-state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions. All the processing is performed by interconnected gates.

As provided herein, the term “autonomous vehicle” (AV) describes any vehicle operating in a state of autonomous control with respect to acceleration, steering, braking, auxiliary controls (e.g., lights and directional signaling), and the like. Different levels of autonomy may exist with respect to AVs. For example, some vehicles may enable autonomous control in limited scenarios, such as on highways. More advanced AVs, such as those described herein, can operate in a variety of traffic environments without any human assistance. Accordingly, an “AV control system” can process sensor data from the AV's sensor array and modulate acceleration, steering, and braking inputs to safely drive the AV along a given route.

Corridor Overview

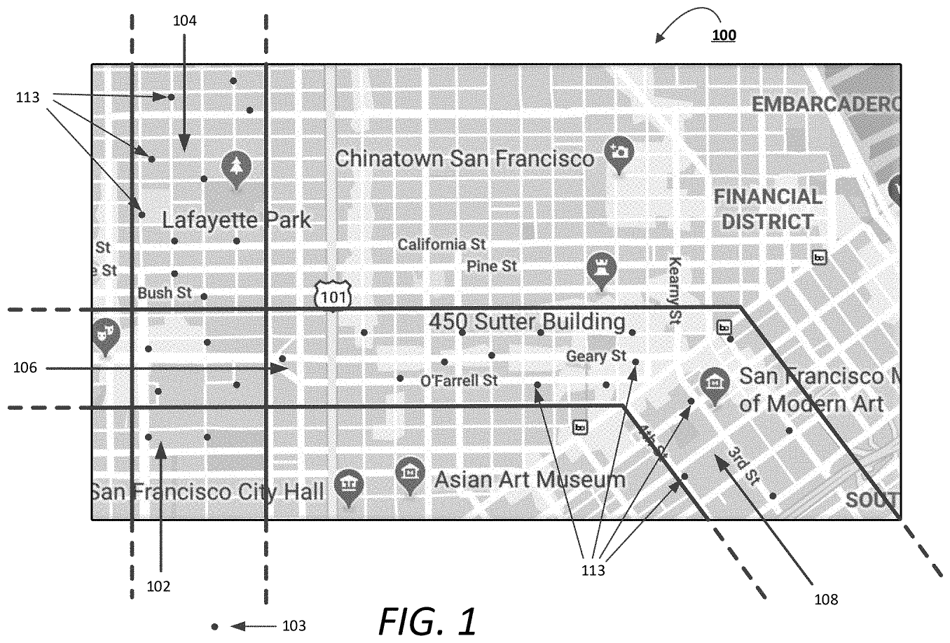

FIG. 1 illustrates a portion of a road network map 100 including visualizations of route corridors through which high capacity vehicles (HCVs) may be dynamically routed to service transport requests, according to examples provided herein. In the example shown in FIG. 1, the road network map 100 can include a number of directional HCV corridors 102, 104, 106, 108 through which an HCV fleet may be routed. In various implementations, the HCV corridors 102, 104, 106, 108 may be selected based on historical data indicating pick-up and drop-off hot spots throughout a transport service region. Furthermore, each HCV corridor 102, 104, 106, 108 is distinct from a fixed route (e.g., such as a bus route). Specifically, each corridor 102, 104, 106, 108 can encompass multiple possible routes.

Further shown in FIG. 1 are pick-up and drop-off locations 113 (signified by the points within the corridors 102, 104, 106, 108). In certain implementations, these locations 113 can comprise fixed locations that are preselected based on historical data compiled for on-demand transport. Accordingly, as HCVs are routed through each directional corridor 102, 104, 106, 108, a remote computing system can dynamically route the HCVs to any particular pick-up/drop-off location 113 depending on real-time transport requests received within that corridor (e.g., which can include the current location of a requesting user and an inputted destination).

While the corridors 102, 104, 106, 108 shown in FIG. 1 generally include straight line boundaries or edges, it is contemplated that certain corridors may have any shape or configuration from a starting area to an ending area. For example, a corridor may have a curvy or irregular shape (e.g., a snakelike shape) that traverses through the road network map 100. In variations, a corridor may include multiple parallel roads with various other roads intersecting throughout the corridor.

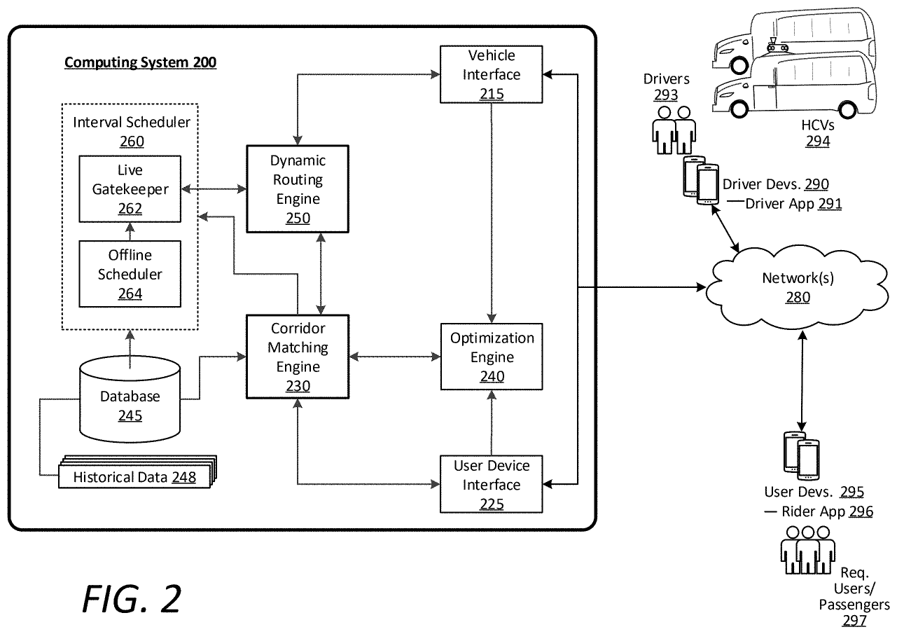

As an example, a remote computing system (described below with respect to FIG. 2) can route an HCV that comes online (e.g., indicating availability) to a start location or area 103 (hereinafter “start zone 103”) of directional corridor 102. From the start zone 103, the HCV can receive match data or routing data, indicating one or more upcoming pick-up or drop-off locations, or routing information to a sequential set of pick-up/drop-off locations through the corridor 102. As provided herein, the corridor 102 may include any number of pick-up/drop-off locations from the start zone 103 to the end of the corridor 102. In one aspect, the computing system can transmit sequential locations dynamically as the HCV operates through the corridor 102. In variations, the computing system can actively and dynamically route the HCV through the corridor based on a variety of factors, as discussed below with respect to FIG. 2.

It is contemplated that the use of corridors for HCVs through a given road network can fulfill a significant percentage of transport requests for a transport service region (e.g., 30-40%), and can provide a cost advantage over current rideshare implementations. Furthermore, the use of HCVs through these corridors can significantly reduce fuel consumption and traffic through optimization of the number of HCVs routed through each corridor, the cadence or interval of HCVs through any given segment of the corridor (e.g., which can respond to real-time and/or forecasted demand conditions), and the active movement of HCVs between corridors based on highly local demand conditions (e.g., from end areas to start zones of respective corridors).

It is further contemplated that the corridors may also be utilized for regular rideshare vehicles. In such examples, the computing system can route a combination of HCVs and other vehicles (e.g., standard rideshare vehicles, carpool vehicles, etc.) through the corridors to meet additional demand. As provided herein, an HCV can comprise a passenger vehicle with a capacity beyond a standard full-size vehicle (e.g., a four-door sedan). For example, an HCV can have a passenger capacity of more than five passengers (e.g., ten to twenty passengers) and can include large SUVs, vans, and buses.

System Description

FIG. 2 illustrates computing system 200 for coordinating navigation of HCVs through established corridors in connection with an on-demand transport service, according to examples described herein. The computing system 200 can include a vehicle interface 215 that can communicate over one or more networks 280 with HCVs 294 operating throughout a given transport service region (e.g., a metropolitan area, such as Manhattan, N.Y.). In certain examples, the vehicle interface 215 can communicate directly with on-board computing systems of the HCVs (e.g., for autonomous HCVs, but also human-driven HCVs with robust computing resources). Additionally or alternatively, the vehicle interface 215 can communicate with the computing devices 290 of the drivers 293 of the HCVs 294 (e.g., via an executing driver application 291 that enables the driver 293 to provide an availability status).

In various implementations, the vehicle interface 215 can receive location data (e.g., GPS data) from the HCVs 294 and/or driver devices 290. The location data can indicate the current location of the HCV 294 as it operates throughout the transport service region. According to examples provided herein, the driver 293 can input, via the executing driver app 291, an availability status to service HCV ride requests. Based on the location data, a dynamic routing engine 250 of the computing system 200 can dynamically route the driver 293 and HCV 294 to a start zone of an optimal corridor, and then dynamically route the driver 293 and HCV 294 through the corridor to an end area.

The computing system 200 can further include a user device interface 225 that can communicate over the network(s) 280 with the computing devices 295 of users 297 of the on-demand transport service (e.g., via an executing rider application 296). The user device interface 225 can receive transport requests from the user devices 295, which can include a current location, an inputted pick-up location, and/or a destination. In various examples, each transport request can indicate a transport service option, such as a standard rideshare option, a carpool option, a luxury vehicle option, or an HCV option. For example, the user 297 can interact with a user interface of the rider application 296 to select any particular transport option. If the current location of the user 297 and the destination inputted by the user 297 match within the boundaries of—or within a threshold distance of—an HCV corridor, the rider application 296 can display the HCV option. It is contemplated that this HCV option can include an upfront cost that is significantly lower than the other options.

Upon receiving an HCV transport request, a corridor matching engine 230 can match the user 297 with a specified corridor based on the current location and destination of the user 297. Specifically, the corridor matching engine 230 can identify a directional HCV corridor that encompasses or closely encompasses the current location and destination of the user 297. For example, the user 297 may be within a three-minute walking distance to the edge of a corridor, and/or the destination of the user 297 may be within a three-minute walking distance of a nearby corridor. Based on this close proximity, the corridor matching engine 230 can match the user 297 to the matching corridor and coordinate with an optimization engine 240 that can identify (i) a most optimal rendezvous location and/or drop-off location for the user 297, and (ii) an upcoming HCV 294 within the matching corridor.

In various examples, the corridor matching engine 230 may identify that the requesting user 297 matches multiple corridors, in which case the optimization engine 240 can perform additional optimizations to determine a most optimal corridor and/or HCV 294 for the user 297. In such examples, the optimization engine 240 can account for each of the optimization factors for each of the multiple corridors described herein, such as whether an upcoming HCV 294 needs to be diverted from a current route and/or the added cumulative delay for each passenger of the upcoming HCV 294.

In certain implementations, the HCV 294 can travel a default or standard route through the corridor, which can be deviated by the dynamic routing engine 250 at any time. For example, the default route can be based on historical transport demand data indicating the most probable fixed locations along the route where requesting users 297 will be located, picked up, and/or dropped off. In some aspects, these most probable locations can be temporally dependent. For example, an HCV 294 traversing the corridor at 8:00 am may travel a different default route than an HCV 294 traversing the corridor at 3:00 pm. However, based on real-time transport requests, the dynamic routing engine 250 and optimization engine 240 can choose to deviate the HCV 294 from its default route.

Specifically, the optimization engine 240 can receive the location and/or current route information of one or more upcoming HCVs and a set of estimated times of arrival (ETAs) of each of the one or more upcoming HCVs to a set of candidate pick-up locations. The optimization engine 240 can further determine an ETA of the user 297 to each candidate pick-up location and select a rendezvous location for the user 297 and upcoming HCV 294 based at least in part on the ETAs. Thereafter, the dynamic routing engine 250 can provide the selected rendezvous location, or routing data comprising turn-by-turn directions to the selected rendezvous location, to the upcoming HCV 294.

Additionally or alternatively, the optimization engine 240 can select a pick-up location based on transport supply and demand parameters, such as other transport requests within the corridor and a weighted cost for deviating the HCV 294 from its current route. For example, the upcoming HCV 294 may be operating along a current route, which the dynamic routing engine 250 can alter at any given time based on output from the optimization engine 240. Specifically, received transport requests from requesting users 297 in a forward operational direction of the upcoming HCV 294 within the corridor can be factored into the weighted cost for deviating the HCV 294 as determined by the optimization engine 240 (e.g., after the HCV has departed from the start location or area).

According to one example, the optimization engine 240 can execute a cost function to output the weighted cost for diverging the HCV 294 to an optimal pick-up location based on an optimization of various factors, such as an arrival time or ETA of the upcoming HCV 294 to each of one or more possible pick-up locations, a wait time for the requesting user 297 at each of the locations, a total added time for the upcoming HCV 294 to diverge from the current route to pick up the user 297, a number of current passengers of the upcoming HCV 294, current transport demand and/or forecasted transport demand on other possible routes of the matching HCV corridor or neighboring corridors, supply efficiency through the corridor (e.g., whether HCVs are aggregating or stacking and the locations or areas of the stacking or aggregation), any previous divergences in the upcoming HCV's route, and the like.

Based on the weighted cost, the dynamic routing engine 250 can determine whether to divert the upcoming HCV 294 or await a next HCV 294 to rendezvous with the user 297. In various examples, the weighted cost also factors in the wait time of the requesting user 297, so the optimization engine 240 can prevent the user 297 from having a lengthy wait time. Furthermore, it is contemplated that the weighted cost can fluctuate based on the dynamic conditions of the scenario. For example, the weighted cost for diverging the HCV 294 can decrease with increased wait times for the user 297. As another example, the weighted cost for diverging the HCV 294 can generally increase based on an increased number of current passengers within the HCV 294 (e.g., due to a higher cumulative added time and inconvenience for diverging the HCV 294).

In various implementations, the computing system 200 can also include or access a database 245 storing historical utilization data 248 of the transport service region. The historical utilization data 248 can comprise data enabling an interval scheduler 260 to forecast demand through each directional HCV corridor. Specifically, the historical utilization data 248 can indicate—physically and temporally—the hot spots for pick-ups and drop-offs for each corridor. The interval scheduler 260 can include an offline scheduler 264 that parses and analyzes these data 248 to determine and establish a schedule for HCVs 294 entering the corridor and/or traversing through any particular segment of the corridor. The offline scheduler 264 can establish the start schedules for each corridor dynamically. That is, as the transport demand fluctuates through the corridor—determined solely from the historical data 248—the offline scheduler 264 establishes the start cadence through each start zone of each corridor of the transport service region.

The interval scheduler 260 can further include a live gatekeeper 262 that receives the start schedule from the offline scheduler 264 and communicates with the computing devices 290 of the drivers 293 and/or the HCVs 294. As drivers 293 and/or HCVs 294 come online (e.g., indicating availability), the live gatekeeper 262 can seek to achieve the established start interval for each corridor of the transport service region. It is to be noted that the drivers 293 can come online at their own discretion, and generally are not beholden to any particular schedule (e.g., besides completing a corridor once started). Accordingly, for each corridor, the established schedule by the offline scheduler 264 may not be accomplished by the live gatekeeper 262.

In further implementations, the live gatekeeper 262 can respond to real-time supply-demand conditions of the HCV transport service, as well as the routing conditions within each corridor. For example, the live gatekeeper 262 can receive input from the corridor matching engine 230 and dynamic routing engine 250, which can indicate route divergences, pick-up locations, current locations and updated routes of each HCV within each corridor, and/or the current locations of the users 297. Generally, if real-time demand in a corridor decreases, the live gatekeeper 262 can increase the start interval for HCVs entering the corridor. If real-time demand increases, the live gatekeeper 262 can decrease the interval accordingly.

According to examples described herein, the live gatekeeper 262 can communicate with the driver application 291 of the computing devices 290 of the drivers 293 or the on-board computing devices of the HCVs 294 to achieve the configured start interval for each corridor. For example, if an HCV is early to the start zone, the live gatekeeper 262 can request, via the driver application 291, that the HCV 294 hold or wait prior to entering the start zone of the corridor. At the desired start time, the live gatekeeper 262 can transmit a message, or content can be displayed via the driver app 291, indicating that the driver may proceed.

It is further contemplated that not only the start interval, but the supply flow of HCVs 294 within the corridors can be manipulated by the live gatekeeper 262 through communications with the drivers 293 and/or HCVs 294. For example, the live gatekeeper 262 can utilize wait requests at any point within the corridor for any particular HCV 294 traversing through the corridor to, for example, prevent stacking or aggregation of HCVs 294 within the corridor that crosses a given threshold of the desired interval (e.g., one HCV 294 every two hundred second with a time threshold of plus or minus twenty seconds).

Computing Device

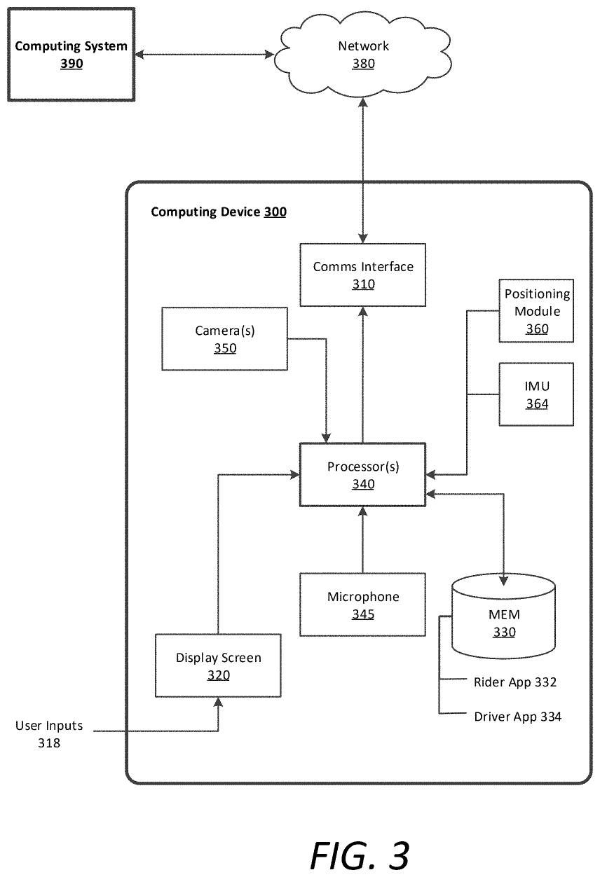

FIG. 3 is an example computing device utilized by requesting users and drivers of an on-demand transport service, as described herein. In many implementations, the computing device 300 can comprise a mobile computing device, such as a smartphone, tablet computer, laptop computer, VR or AR headset device, and the like, and can be controlled by either a human driver 293 or a requesting user 297 described with respect to FIG. 2. The computing device 300 can include typical telephony features such as a microphone 345, one or more cameras 350 (e.g., a forward-facing camera and a rearward-facing camera), and a communication interface 310 to communicate with external entities using any number of wireless communication protocols. The computing device 300 can further include a positioning module 360 and an inertial measurement unit 364 that includes one or more accelerometers, gyroscopes, or magnetometers. In certain aspects, the computing device 300 can store a designated application (e.g., a rider app 332) in a local memory 330. In the context of FIG. 1, the rider app 332 can comprise the rider app 296 executable on the user device 295 of FIG. 2. In variations, the memory 330 can store additional applications executable by one or more processors 340 of the user device 300, enabling access and interaction with one or more host servers over one or more networks 380.

In response to a user input 318, the rider app 332 can be executed by a processor 340, which can cause an app interface to be generated on a display screen 320 of the computing device 300. The app interface can enable the user to, for example, configure an on-demand transport request, or display turn-by-turn map or walking directions (e.g., based on route data transmitted by the network computing system 390). In various implementations, the app interface can further enable the user to enter or select a destination location (e.g., by entering an address, performing a search, or selecting on an interactive map). The user can generate the transport request via user inputs 318 provided on the app interface. For example, the user can input a destination and select a transport service option to configure the transport request, and select a request feature that causes the communication interface 310 to transmit the transport request to the network computing system 390 over the one or more networks 380.

As provided herein, the rider application 332 can further enable a communication link with a network computing system 390 over the network(s) 380, such as the computing system 100 as shown and described with respect to FIG. 1. The processor 340 can generate user interface features (e.g., map, request status, etc.) using content data received from the network computing system 390 over the network(s) 380.

The processor 340 can transmit the transport requests via a communications interface 310 to the backend network computing system 390 over the network 380. In response, the computing device 300 can receive a confirmation from the network system 390 indicating the selected driver that will service the request. In various examples, the computing device 300 can further include a positioning module 360, which can provide location data indicating the current location of the requesting user to the network system 390 to, for example, determine the rendezvous location.

For drivers, the computing device 300 can execute a designated driver application 334 that enables the driver to input an on-duty or available status. In some examples, the driver app 334 can further enable the driver to select one or multiple types of transport service options to provide to requesting users, such as a standard on-demand rideshare option, a carpool option, or an HCV option. For the latter option, the computing system 390 can coordinate with the driver to route the driver to the start zone of an optimal corridor, provide dynamic routing updates based on transport requests in a forward operational direction of the HCV through the corridor, and perform the live gatekeeping operations, as described herein.

Methodology

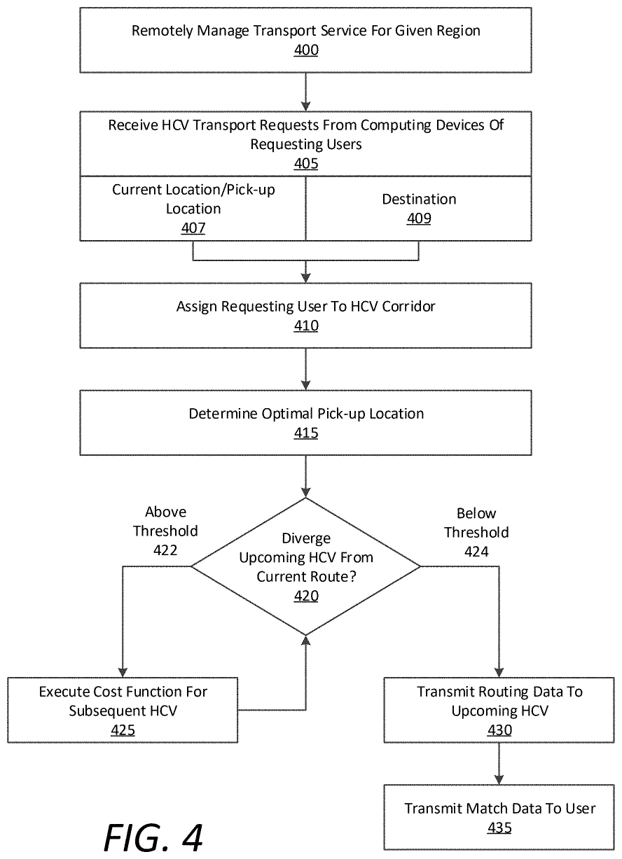

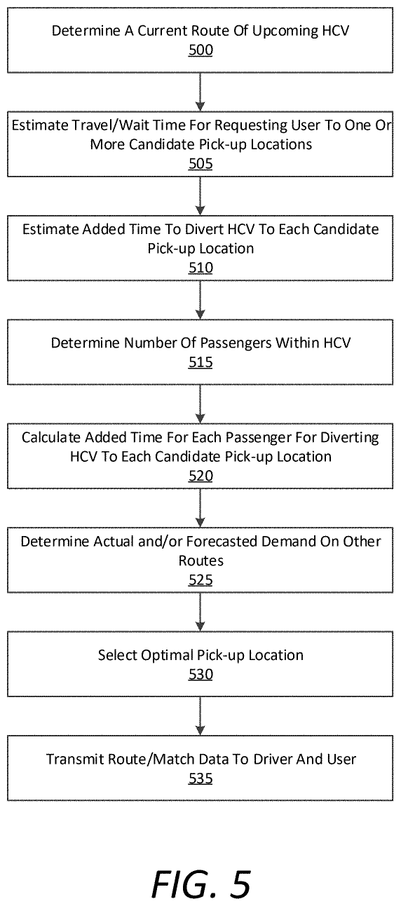

FIGS. 4 and 5 are flow charts describing example methods of dynamically routing HCVs through established corridors of a transport service region, according to examples described herein. In the below descriptions of FIGS. 4 and 5, reference may be made to reference characters representing like features shown and described with respect to FIGS. 1 through 3. Furthermore, the steps and processes described with respect to FIGS. 4 and 5 below may be performed by an example computing system 200, as described herein with respect to FIG. 2. Still further, any step described with respect to either FIG. 4 or FIG. 5 may be performed in parallel with or replace any other step described. Furthermore, the steps provided in FIGS. 4 and 5 need not be performed in the order(s) described, but may rather be performed in any suitable order, may be performed in parallel to any other particular step, or may be omitted from the process.

Referring to FIG. 4, the computing system 200 can remotely manage an on-demand transport service for a given region (400). The computing system 200 can receive HCV transport requests from the computing devices 295 of requesting users 297 (405). In various examples, the HCV transport request can include the current location or a desired pick-up location (407). The HCV transport request can also include a desired destination (409). In various examples, the computing system 200 can assign the requesting user 297 to an HCV corridor based on the current location of the user 297 (or desired pick-up location) and the destination (410). The computing system 200 may then determine an optimal pick-up location within the corridor (415).

In certain implementations, the computing system 200 can determine whether to diverge an upcoming HCV 294 within the corridor from its current route (420). It is contemplated that the determination of both the optimal pick-up location and the route divergence of the upcoming HCV 294 can be performed through execution of a cost function. For example, if the weighted cost of diverging the HCV 294 to an optimal rendezvous location with the user 297 is above a certain threshold (422), then the computing system 200 will not diverge the upcoming HCV 294, and execute the cost function for the subsequent HCV (425).

However, if the weighted cost is below the threshold (424), then the computing system 200 can transmit routing data to the upcoming HCV 294 to enable the HCV 294 to rendezvous with the requesting user 297 at the optimal pick-up location (430). As described herein, the routing data can simply comprise the optimal pick-up location. In variations, the routing data can provide turn-by-turn directions to the optimal pick-up location. Thereafter, the computing system 200 can transmit match data to the requesting user 297 indicating the optimal pick-up location (435).

FIG. 5 is a flow chart describing the execution of an example cost function for selecting an optimal pick-up location and/or determining whether to divert an upcoming HCV from a current or default route, according to examples described herein. Referring to FIG. 5, given a received HCV transport request, the computing system 200 can determine a current route of an upcoming HCV in the corridor (500). In various examples, the computing system 200 can determine a travel time and/or wait time for the requesting user 297 to one or more candidate pick-up locations (505). The computing system 200 can further estimate an added time to the divert the upcoming HCV 294 to each candidate pick-up location (510).

In various implementations, the computing system 200 can determine a number of passengers within the upcoming HCV 294 (515). In some examples, the computing system 200 can calculate or estimate an added time for each passenger for diverting the HCV 294 from the current route (520). Additionally or alternatively, the computing system 200 can determine actual demand (e.g., real-time) and/or forecasted demand (e.g., predicted) for HCV transport within the corridor on other possible routes in a forward operational direction through the corridor (525). Based on all of the foregoing factors, the computing system 200 can execute one or more cost functions to select an optimal pick-up location for the HCV 294 to rendezvous with the user 297 (530), and transmit routing and/or match data to the driver 293 of the HCV 294 and the requesting user 297 (535).

Hardware Diagram

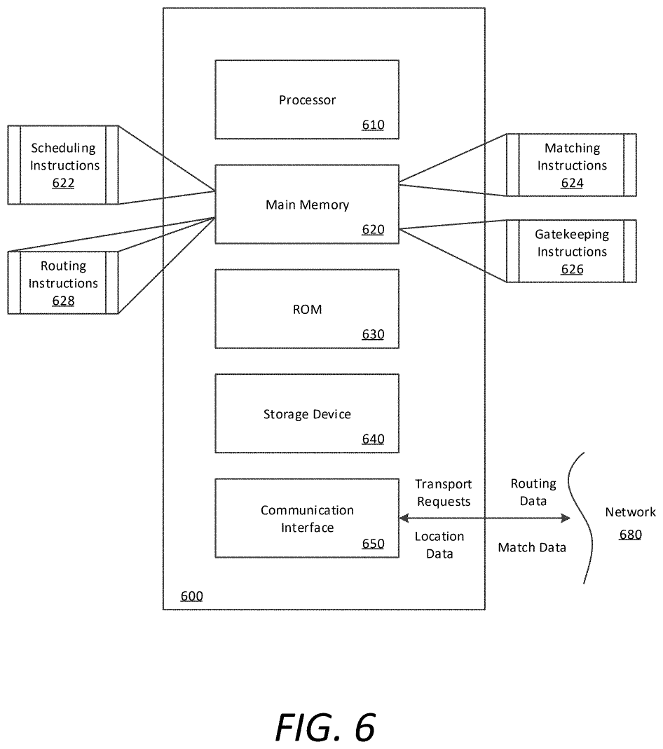

FIG. 6 is a block diagram that illustrates a computing system upon which examples described herein may be implemented. A computing system 600 can be implemented on, for example, a server or combination of servers. For example, the computing system 600 may be implemented as part of an on-demand transport service, such as described in FIGS. 2 and 3. In the context of FIG. 2, the computing system 200 may be implemented using a computer system 600 such as described by FIG. 6. The computing system 200 may also be implemented using a combination of multiple computer systems as described in connection with FIG. 6.

In one implementation, the computing system 600 includes processing resources 610, a main memory 620, a read-only memory (ROM) 630, a storage device 640, and a communication interface 650. The computing system 600 includes at least one processor 610 for processing information stored in the main memory 620, such as provided by a random-access memory (RAM) or other dynamic storage device, for storing information and instructions which are executable by the processor 610. The main memory 620 also may be used for storing temporary variables or other intermediate information during execution of instructions to be executed by the processor 610. The computing system 600 may also include the ROM 630 or other static storage device for storing static information and instructions for the processor 610. A storage device 640, such as a magnetic disk or optical disk, is provided for storing information and instructions.

The communication interface 650 enables the computing system 600 to communicate with one or more networks 680 (e.g., cellular network) through use of the network link (wireless or wired). Using the network link, the computing system 600 can communicate with one or more computing devices, one or more servers, one or more databases, and/or one or more self-driving vehicles. In accordance with examples, the computing system 600 receives transport requests from mobile computing devices of individual users. The executable instructions stored in the memory 630 can include matching instructions 624, which the processor 610 executes to receive HCV transport requests and match a requesting user with an HCV corridor, as described herein.

The executable instructions stored in the memory 620 can also include scheduling instructions 622 and gatekeeping instructions 626, which the processor 610 can execute to establish a start schedule or interval for each corridor using historical utilization data, and respond to real-time conditions (e.g., drivers coming online and demand conditions) to perform the gatekeeping operations described herein. The executable instructions can also include routing instructions 628, which the processor 610 can execute to determine weighted costs for dynamically routing HCVs through corridors.

Examples described herein relate to the use of the computing system 600 for implementing the techniques described herein. According to one example, those techniques are performed by the computing system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an aspect, can be combined with other individually described features, or parts of other aspects. Thus, absence of describing combinations should not preclude the inventors from claiming rights to such combinations.

What is claimed is:

1. A computing system implementing a transport service for a geographic region, comprising:
a network communication interface;
one or more processors;
a memory storing instructions that, when executed by the one or more processors, cause the computing system to:
receive, via the network communication interface, transport requests from computing devices of requesting users of the transport service;
for each transport request received from the computing device of each requesting user:
assign the transport request to a high capacity vehicle (HCV) corridor of a plurality of HCV corridors, the HCV corridor being associated with (i) a plurality of possible rendezvous locations and (ii) a plurality of possible routes that can be traveled by individual HCVs;
determine, from the transport request of the requesting user, an optimal pick-up location from the plurality of possible rendezvous locations of the HCV corridor for an HCV to rendezvous with the requesting user;
receive, via the network communication interface, location information from a computing device associated with a first HCV;
determine, based on the location information, a current route of the plurality of possible routes within the HCV corridor that the first HCV is currently traversing, wherein the optimal pick-up location is not located along the current route;
transmit, via the network communication interface, data indicating the optimal pick-up location to the computing device associated with the HCV; and
transmit, via the network communication interface, data indicating the optimal pick-up location for the requesting user to the computing device of the requesting user.

2. The computing system of claim 1, wherein the executed instructions cause the computing system to determine the optimal pick-up location by determining a weighted cost for the HCV to diverge from the current route.

3. The computing system of claim 2, wherein the executed instructions cause the computing system to determine the weighted cost based on an optimization of an arrival time of the HCV, a wait time for the requesting user, an additional time for the HCV to diverge from the current route, and a number of current passengers of the HCV.

4. The computing system of claim 3, wherein the optimization to determine the weighted cost further factors in at least one of current transport demand or forecasted transport demand on other possible routes of the assigned HCV corridor.

5. The computing system of claim 1, wherein the assigned HCV corridor comprises one of a plurality of HCV corridors established throughout the geographic region, each respective HCV corridor of the plurality of HCV corridors encompassing a plurality of possible routes from a start point of the respective HCV corridor to an end point of the respective HCV corridor.

6. The computing system of claim 5, wherein the executed instructions cause the computing system to assign the transport request to the assigned HCV corridor by (i) identifying a destination of the requesting user indicated in the transport request, (ii) determine, from the plurality of HCV corridors of the geographic region, that the assigned HCV corridor encompasses the optimal pick-up location and the destination of the requesting user.

7. The computing system of claim 1, wherein each of the plurality of possible rendezvous locations comprises a fixed pick-up and drop-off location within the assigned HCV corridor.

8. A non-transitory computer-readable medium storing instructions that, when executed by one or more processors of a computing system, cause the computing system to:
receive, via a network communication interface, transport requests from computing devices of requesting users of a transport service for a geographic region;
for each transport request received from the computing device of each requesting user:
assign the transport request to a high capacity vehicle (HCV) corridor of a plurality of HCV corridors, the HCV corridor being associated with (i) a plurality of possible rendezvous locations and (ii) a plurality of possible routes that can be traveled by individual HCVs;
determine, from the transport request of the requesting user, an optimal pick-up location from the plurality of possible rendezvous locations of the HCV corridor for an HCV to rendezvous with the requesting user;
receive, via the network communication interface, location information from a computing device associated with a first HCV;
determine, based on the location information, a current route of the plurality of possible routes within the HCV corridor that the first HCV is currently traversing, wherein the optimal pick-up location is not located along the current route;
transmit, via the network communication interface, data indicating the optimal pick-up location to the computing device associated with the HCV; and
transmit, via the network communication interface, data indicating the optimal pick-up location for the requesting user to the computing device of the requesting user.

9. The non-transitory computer-readable medium of claim 8, wherein the executed instructions cause the computing system to determine the optimal pick-up location by determining a weighted cost for the HCV to diverge from the current route.

10. The non-transitory computer-readable medium of claim 9, wherein the executed instructions cause the computing system to determine the weighted cost based on an optimization of an arrival time of the HCV, a wait time for the requesting user, an additional time for the HCV to diverge from the current route, and a number of current passengers of the HCV.

11. The non-transitory computer-readable medium of claim 10, wherein the optimization to determine the weighted cost further factors in at least one of current transport demand or forecasted transport demand on other possible routes of the assigned HCV corridor.

12. The non-transitory computer-readable medium of claim 8, wherein the assigned HCV corridor comprises one of a plurality of HCV corridors established throughout the geographic region, each respective HCV corridor of the plurality of HCV corridors encompassing a plurality of possible routes from a start point of the respective HCV corridor to an end point of the respective HCV corridor.

13. The non-transitory computer-readable medium of claim 12, wherein the executed instructions cause the computing system to assign the transport request to the assigned HCV corridor by (i) identifying a destination of the requesting user indicated in the transport request, (ii) determine, from the plurality of HCV corridors of the geographic region, that the assigned HCV corridor encompasses the optimal pick-up location and the destination of the requesting user.

14. The non-transitory computer-readable medium of claim 8, wherein each of the plurality of possible rendezvous locations comprises a fixed pick-up and drop-off location within the assigned HCV corridor.

15. A computer-implemented method of coordinating transport, the method being performed by one or more processors of a computing system and comprising:
receiving, via a network communication interface, transport requests from computing devices of requesting users of a transport service for a geographic region;
for each transport request received from the computing device of each requesting user:
assigning the transport request to a high capacity vehicle (HCV) corridor of a plurality of HCV corridors, the HCV corridor being associated with (i) a plurality of possible rendezvous locations and (ii) a plurality of possible routes that can be traveled by individual HCVs;
determining, from the transport request of the requesting user, an optimal pick-up location from the plurality of possible rendezvous locations of the HCV corridor for an HCV to rendezvous with the requesting user;
receiving, via the network communication interface, location information from a computing device associated with a first HCV;
determining, based on the location information, a current route of the plurality of possible routes within the HCV corridor that the first HCV is currently traversing, wherein the optimal pick-up location is not located along the current route;
transmitting, via the network communication interface, data indicating the optimal pick-up location to the computing device associated with the HCV; and
transmitting, via the network communication interface, data indicating the optimal pick-up location for the requesting user to the computing device of the requesting user.

16. The method of claim 15, wherein the one or more processors determine the optimal pick-up location by determining a weighted cost for the HCV to diverge from the current route.

17. The method of claim 16, wherein the one or more processors determine the weighted cost based on an optimization of an arrival time of the HCV, a wait time for the requesting user, an additional time for the HCV to diverge from the current route, and a number of current passengers of the HCV.

18. The method of claim 17, wherein the optimization to determine the weighted cost further factors in at least one of current transport demand or forecasted transport demand on other possible routes of the assigned HCV corridor.

19. The method of claim 15, wherein the assigned HCV corridor comprises one of a plurality of HCV corridors established throughout the geographic region, each respective HCV corridor of the plurality of HCV corridors encompassing a plurality of possible routes from a start point of the respective HCV corridor to an end point of the respective HCV corridor.

20. The method of claim 19, wherein the one or more processors assign the transport request to the assigned HCV corridor by (i) identifying a destination of the requesting user indicated in the transport request, (ii) determine, from the plurality of HCV corridors of the geographic region, that the assigned HCV corridor encompasses the optimal pick-up location and the destination of the requesting user.
